(19) United States
(12) Patent Application Publication
(10) Pub. No.: US 2026/0156491 A1
(43) Pub. Date: Jun. 4, 2026

(54) METHODS AND SYSTEMS FOR OPTIMIZING CAPABILITIES INFORMATION EXCHANGE IN A MOBILE COMMUNICATIONS NETWORK

(71) Applicant: Verizon Patent and Licensing Inc., Basking Ridge, NJ (US)

(72) Inventors: Andrew E. Youtz, Princeton, NJ (US); Jeremy Nacer, Boca Raton, FL (US); Cindy Yuexin Dong, Bridgewater, NJ (US)

(21) Appl. No.: 18/964,005

(22) Filed: Nov. 29, 2024

(51) Int. Cl. H04W 24/02; H04W 8/22; H04W 60/04; H04W 76/20

(52) U.S. Cl. CPC H04W 24/02; H04W 8/22; H04W 60/04; H04W 76/20

(57) ABSTRACT

A method, a network environment, and a non-transitory computer-readable storage medium are described in relation to UE capabilities exchange methodology. The methodology may include receiving, by a user equipment device (UE), a setup message from an access network device; identifying, by the UE, one or more radio capability signaling optimization identifiers (RACS IDs), wherein each of the one or more RACS IDs identifies a set of radio capabilities; and generating, by the UE, a response to the access network device that includes the one or more RACS IDs. In response, the access network device retrieves UE capabilities information based on the one or more RACS IDs; and transmits a message to a core network device that includes at least some of the UE capabilities information.

### BACKGROUND

Development and design of networks present certain challenges from a network-side perspective and an end device perspective. With respect to Next Generation (NG) wireless networks, such as Fifth Generation New Radio (5G NR) networks or hybrid 5G NR and fourth generation (4G) networks, such as Long Term Evolution (LTE) networks, efficient exchange of accurate end user equipment (UE) capabilities information (UCI) is necessary to ensure effective delivery of network services and optimization of network and UE resources.

### BRIEF DESCRIPTION OF THE DRAWINGS

FIG. 1 is a diagram illustrating an exemplary environment in which an exemplary embodiment of a UE capabilities information exchange methodology may be implemented;

FIG. 2A is a diagram illustrating an exemplary process of an exemplary embodiment of the UE capabilities information exchange methodology;

FIG. 2B is a diagram that illustrates an exemplary embodiment of a UE capabilities mapping table consistent with implementations described herein;

FIG. 2C is a diagram illustrating another exemplary process of an exemplary embodiment of the UE capabilities information exchange methodology;

FIG. 2D is a diagram that illustrates still another exemplary embodiment of the UE capabilities information exchange methodology;

FIG. 3 is a diagram illustrating exemplary components of a device that may correspond to one or more of the devices illustrated and described herein;

FIG. 4 is a flow diagram illustrating an exemplary process of an exemplary embodiment of the UE capabilities information exchange methodology; and

FIG. 5 is a flow diagram illustrating another exemplary process of an exemplary embodiment of the UE capabilities information exchange methodology.

### DETAILED DESCRIPTION

The following detailed description refers to the accompanying drawings. The same reference numbers in different drawings may identify the same or similar elements. Also, the following detailed description does not limit the invention.

A wireless network operator may provide network services in several different implementations potentially simultaneously or complementarily, such as legacy 4G networks (e.g., LTE), non-standalone 5G networks (e.g., 5G NSA), which support 5G access technology with a 4G core network, and standalone fifth generation networks (5G SA). Each of these network architectures may offer or support various frequency bands, carriers, radio frequencies (RFs), and/or another type of segment of radio spectrum (simply referred to as radio frequency) that an end device may use for connectivity to an application service.

To enable accurate and optimal communications between connecting user equipment devices (UEs), attachment to a network typically includes a request and provision of UE capabilities information (UCI), sometimes referred to as device capabilities information (DCI). For example, a radio access network (RAN) terminal may, during an attachment procedure, transmit a request for capabilities information to an attaching UE. In response, the UE may transmit messaging indicative of its capabilities to the requesting RAN terminal. Depending on the implementation and the content of the request, the provided DCI may include, for example, information regarding carrier aggregation (CA) capabilities, MIMO (Multiple Input Multiple Output) support, identification of the frequency bands, modulation schemes, and advanced scheduling and transmission techniques supported by the UE, such as CoMP (Coordinated Multi-Point), HARQ (Hybrid Automatic Repeat Request), etc.

In 5G networks, UCI may include or reference additional capability information, as support for additional 5G NR frequency bands in the Sub-6 GHz (FR1) and/or millimeter-wave (mmWave) frequencies (FR2), the UE's support for massive MIMO and beamforming techniques, identification of supported CA carrier combinations (e.g., LTE+NR, NR+NR), support for dual connectivity techniques, which allow simultaneous connection to both LTE and 5G networks, and an indication of any advanced coding and modulation techniques supported by the UE.

More specifically, CA is a technique used to combine multiple carrier frequencies to increase bandwidth and improve data rates. In both LTE and 5G, UEs may support different configurations for carrier aggregation. For UEs that support CA, a provided DCI will generally specify how many carrier frequencies that can be combined (e.g., 2 component carrier (CC), 3CC, or more), the UE's maximum bandwidth for each carrier, and which frequency bands the UE can combine, whether in LTE or 5G. For example, a UE may support combining Band 7 (2600 MHz) with Band 20 (800 MHz) in LTE, or NR carrier aggregation in FR1 (Sub-6 GHz) or FR2 (mmWave) for 5G. A provided UCI may further specify an aggregation type (e.g., contiguous or non-contiguous).

Dual connectivity (DC) is a feature that allows a UE to be connected simultaneously to two different radio access technologies, such as LTE and 5G. In relation to DC, the device capability information is used to inform the network about the UE's ability to handle both LTE and 5G connections simultaneously. For example, device capabilities information may indicate whether the UE supports DC; information regarding support for carrier aggregation between LTE and NR; and information regarding support for various dual connectivity types, such as dual connectivity with LTE as the primary cell (PCell) and NR as the secondary cell (SCell), and/or dual connectivity with NR as the PCell and LTE as the SCell. In other implementations, dual connectivity may refer to connection via two different NR carriers in SA 5G, such as FR1 and FR2.

With the advent and implementation of such advanced network technologies, the exchange of UCI has become increasingly cumbersome and inefficient, requiring significant overhead resources during network attachment. Upon attachment to a network, UEs would transmit large amounts of capability information that may not have been necessary for the network at all times. This leads to several issues, such as excessive signaling overhead, redundant signaling, where the same capabilities were communicated repeatedly, consuming valuable network resources, inefficiency in resource allocation, as the network might not always receive the most up-to-date or relevant capabilities, which could affect optimization of connection setups like carrier aggregation, dual connectivity, or beamforming.

To provide an alternative to complete capability reporting at each attachment, in some implementations, the UE and network may support UE radio capability signaling optimization (RACS) in which the UE utilizes a previously established or defined RACS identifier (ID) to indicate its capabilities to the network. Unfortunately, a comprehensive implementation of RACS fails to address particular operational considerations. For example, in operation, a radio access network device (e.g., a wireless station, such as an evolved Node B (eNB) or next generation Node B (gNB)) may typically only request capabilities for frequency bands supported in a given region in which it is located. Consequently, a capabilities response may not contain the capabilities for all frequency bands supported on the network, since an appropriate capabilities information response may vary based on the region and the frequency bands requested by the network. In another operational consideration, updates to UEs (such as updates to modem firmware or software) may result in changes to its capabilities which may not be accurately reflected in previously established RACS identifier (ID) configurations, resulting in inaccurate or out of date capabilities information being retrieved by the network, via an outdated RACS ID.

According to exemplary embodiments described herein, an improved capability exchange methodology may be implemented. In one exemplary implementation, RAN devices (e.g., eNBs or gNBs) may be updated to request capabilities information for an entirety of the network, irrespective of any regional differences that may have been provided in prior capabilities requests. In another exemplary implementation, regardless of a region in which a particular RAN device is located, UEs may be configured to provide all RACS IDs assigned to the UE upon each attachment to the network. In response, the RAN device selects one of the RACS IDs provided by the UE based on its region configuration. If necessary, RAN device may retrieve capabilities information associated with two or more RACS IDs and concatenate them together to create a complete capabilities information for the attaching UE. In this embodiment, if no provided RACS IDs are associated with the current region or capabilities of the RAN device, the RAN device may initiate a follow-up with the UE via a traditional capabilities enquiry and response exchange.

In another exemplary implementation, the network may assign a series of RACS IDs to a UE based on frequency bands and network pre-configurations, such as geographic regions having particular available frequency bands, particular UE modem chipsets, etc. The UE may provide appropriate RACS IDs to the particular RAN device upon attachment.

In another exemplary implementation, to signal an update to UE, such as a modem or other configuration (such as CA or DC configuration), the UE may be configured to provide no RACS IDs or a pre-configured, update indicated RACS ID, in the initial attach/registration procedure. In response, the RAN device may perform a UE capabilities enquiry (UCE)-UCI exchange and may overwrite any existing network assigned RACS IDs based on information included in the received UCI.

In still another exemplary implementation, RACS IDs may be associated with particular sets of UE capabilities information by UE device manufacturers. The pre-configured RACS IDs may be shared with the network prior to device registration. Such pre-defined RACS IDs may be based on device type (e.g. smartphone, tablet, hotspot, etc.), modem chipset and software version, device tier (e.g. flagship, premium, entry, etc.), etc. During network attach/registration, the UE may include one or more of the pre-defined RACS ID's.

In yet another exemplary implementation, efficient capability exchange may be enhanced by defining additional non-standard, pre-configured items of capabilities information, which may be shared with the network via traditional UCE-UCI messaging. For example, supported carrier aggregation combinations may be assigned a pre-defined CA ID number, which may be provided by the UE to the network in response to a UCE message.

In view of the foregoing, UE capability information may be exchanged with a network in an efficient manner, while maintaining an ability to accurately respond to changes in device capabilities and network capabilities.

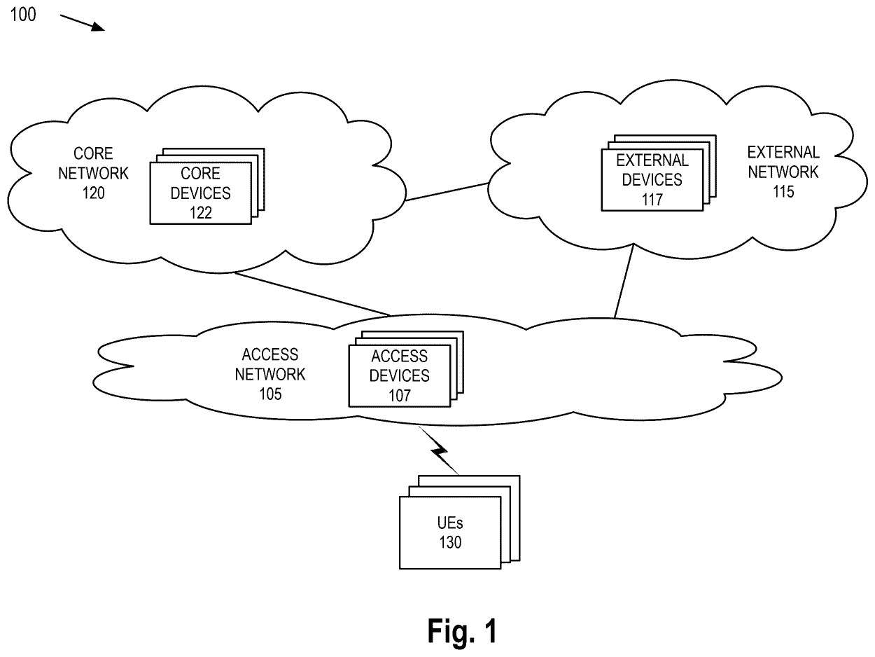

FIG. 1 is a diagram illustrating an exemplary environment 100 in which an exemplary embodiment of a UE capabilities information exchange methodology may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices/user equipment devices (UEs) 130 (also referred to individually or generally as end device or UE 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane (UP), a service plane, and a network management plane. Environment 100 may include other types of planes of communication. A message communicated in support of the UE capabilities information exchange methodology may use at least one of these planes of communication. According to various exemplary implementations, the interface of the network device may be a service-based interface, a reference point-based interface, an Open Radio Access Network (O-RAN) interface, a 5G interface, another generation of interface (e.g., 5G Advanced, Sixth Generation (6G), Seventh Generation (7G), etc.), or some other type of network interface (e.g., proprietary, etc.).

Access network 105 may include one or multiple networks of one or multiple types and technologies. For example, access network 105 may be implemented to include a 5G RAN, a future generation RAN (e.g., a 6G RAN, a 7G RAN, etc.), a centralized-RAN (C-RAN), a virtualized RAN (vRAN), an O-RAN, and/or another type of access network. Consistent with embodiments described herein, access network 105 may include a legacy RAN (e.g., a Third Generation (3G) RAN, a 4G RAN, etc.). Access network 105 may communicate with and/or include other types of access networks, such as, for example, a Wi-Fi network, a local area network (LAN), a Citizens Broadband Radio System (CBRS) network, a cloud RAN, a self-organizing network (SON), a wired network (e.g., optical, cable, etc.), or another type of network that provides access to or can be used as an on-ramp to access network 105 and/or core network 120.

Access network 105 may include different and multiple functional splitting, such as options 1, 2, 3, 4, 5, 6, 7, or 8 that relate to combinations of access network 105 and core network 120 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a gNB, an enhanced LTE (eLTE) eNB, an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN gNB, O-RAN-eNB), a 5G ultra-wide band (UWB) node, and/or a future generation wireless access device (e.g., a 5G advanced wireless station, a 6G wireless station, a 7G wireless station, or another generation of wireless station). Access devices 107 may include a transport device (e.g., a router or similar network device).

In some embodiments, access device 107 may include other types of wireless access devices, such as a Wi-Fi device, a hotspot device, and/or a fixed wireless access customer premise equipment (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to various exemplary implementations, access device 107 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 107 may provide a wireless access service at a cell, a sector, a sub-sector/zone, carrier, and/or other configurable level, sometimes referred to as a region.

According to some exemplary embodiments, at least some of access devices 107, as described herein, include an exemplary embodiment of the UE capabilities information exchange methodology, either independently, or in combination with devices of core network 120. For example, access devices 107 may include logic that supports or implements the UE capabilities information exchange methodology. According to such an embodiment, access device 107 may receive RACS IDs and or items of UE capabilities information associated with an attach procedure from a UE 130 and may retrieve, process, or request additional items of UE capabilities information based on the received information, as described herein.

External network 115 may include one or multiple networks of one or multiple types and technologies that provide an application service. For example, external network 115 may be implemented using one or multiple technologies including, for example, network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or another type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, transport devices, data center devices, NFV devices, SDN devices, cloud computing devices, platforms, and other types of network devices pertaining to various network-related functions (e.g., security, management, charging, billing, authentication, authorization, policy enforcement, development, etc.).

External devices 117 may host one or multiple types of application services. For example, such application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, online gaming, web services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and the like. External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, a 5G Advanced core network, an EPC of an LTE network, an LTE-Advanced (LTE-A) network, and/or an LTE-A Pro network, a future generation core network (e.g., a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), a network exposure function (NEF), a service capability exposure function (SCEF), a lifecycle management (LCM) device, a mobility management entity (MME), a packet data network gateway (PGW), an enhanced packet data gateway (ePDG), a wireless access gateway (WAG), a tunnel termination gateway (TTG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), a charging system (CS), a transport device, and/or a future generation core device 122 that may perform a similar function.

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Consistent with implementations described herein, core devices 122 may also include a network device that provides a multi-RAT functionality (e.g., 4G and 5G, 5G and 6G, 5G Advanced and 6G, 6G and 7G, etc.), such as an SMF with PGW control plane functionality (e.g., SMF+PGW-C), a UPF with PGW user plane functionality (e.g., UPF+PGW-U), and/or other combined nodes (e.g., an HSS with a UDM/UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to some exemplary embodiments, at least some of core devices 122, as described herein, include elements that support the UE capabilities information exchange methodology described herein. For example, according to an exemplary embodiment, an MME and/or AMF may include logic for supporting the storage of UE capabilities information for UEs 130 on core network 120, for future retrieval during subsequent connection requests, as described herein.

UE 130 may include a device that may have communication capabilities (e.g., wireless, wired, optical, etc.). UE 130 may or may not have computational capabilities. UE 130 may be implemented as a mobile device, a portable device, a stationary device (e.g., a non-mobile device and/or a non-portable device), a device operated by a user, or a device not operated by a user. For example, UE 130 may be implemented as a smartphone, a mobile phone, a tablet, a wearable device (e.g., a watch, glasses, headgear, a band, etc.), a computer, a gaming device, a music device, an IoT device, a drone, a smart device, an autonomous vehicle, or another type of wireless device (e.g., another type of user equipment (UE)). UE 130 may or may not be configured to execute diverse types of software (e.g., applications, programs, etc.). The number and the types of software may vary among UEs 130. UE 130 may include “edge-aware” and/or “edge-unaware” application service clients. UE 130 may be implemented as a virtualized device in whole or in part. For purposes of description, UE 130 is not considered a network device.

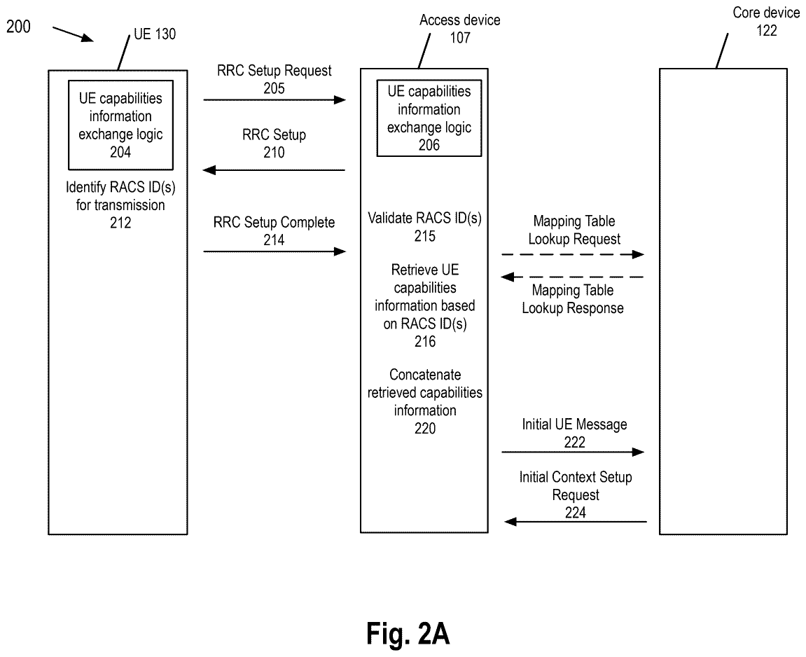

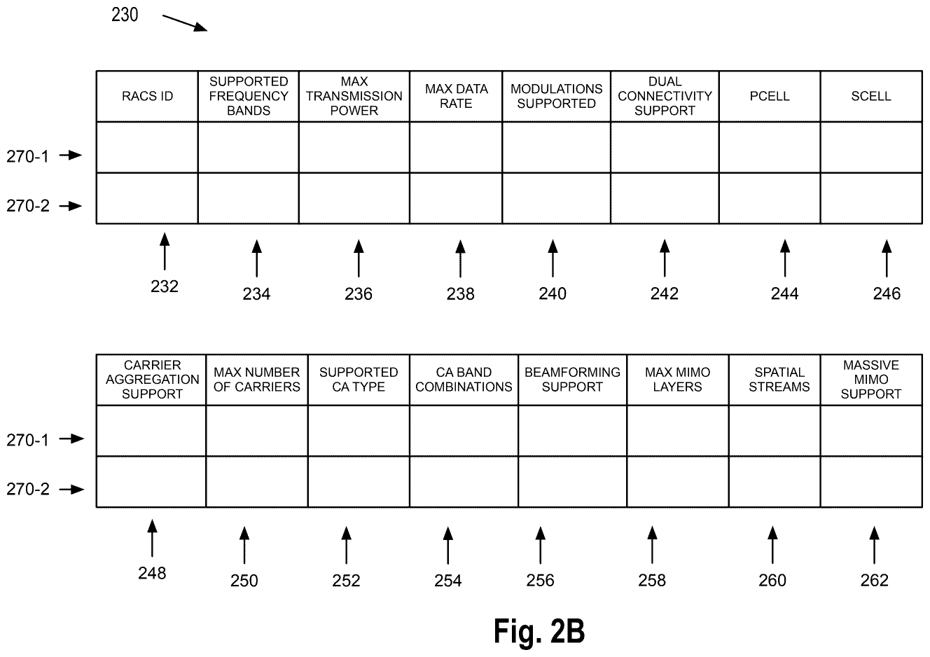

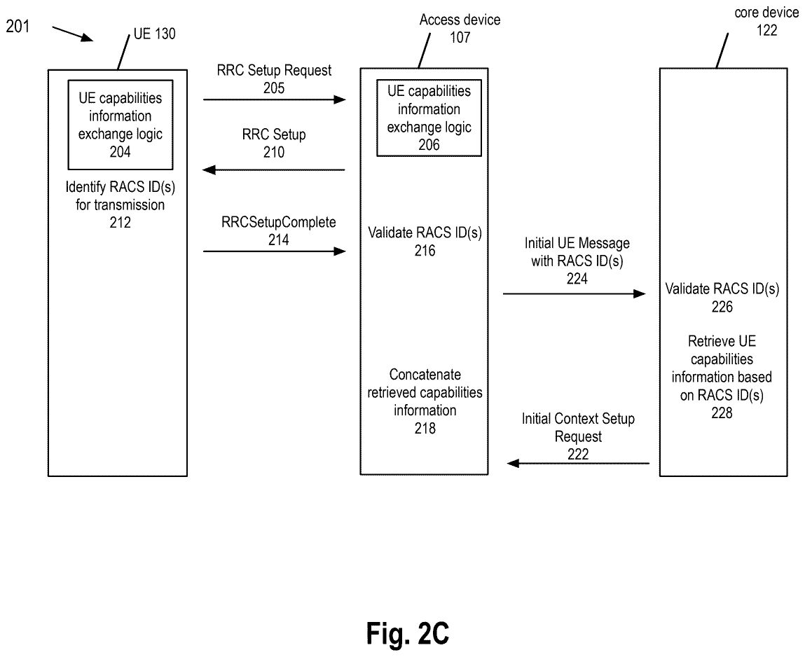

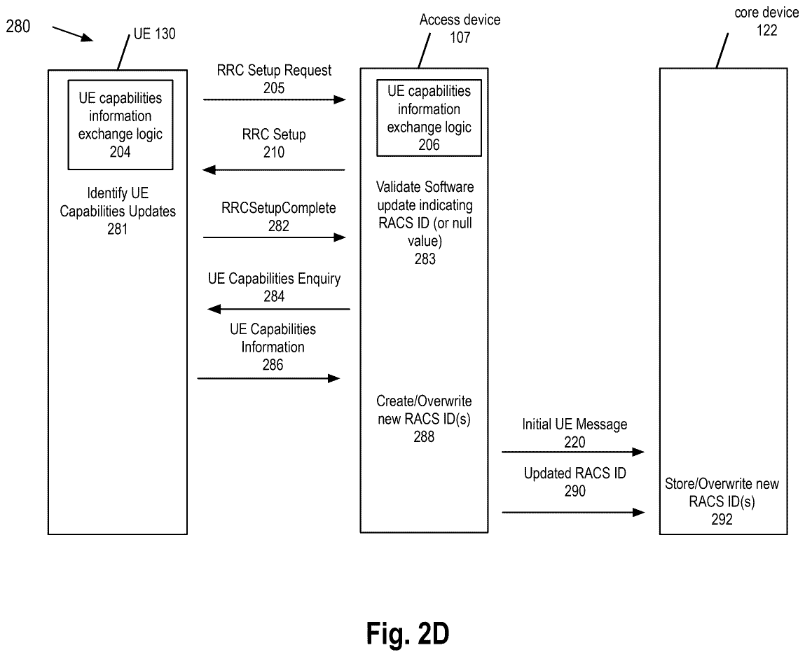

FIG. 2A is a diagram illustrating an exemplary process 200 of an exemplary embodiment of the UE capabilities information exchange methodology implemented in an exemplary environment. According to this example, the exemplary environment may be implemented to include UE 130, access device 107, and core device 122. According to exemplary embodiment, access device 107 may be implemented as a wireless station (e.g., integrated or split), such as a gNB or an RU+DU, for example, and core device 122 may be implemented as an MME, AMF, or other network function, depending on the radio access technology (RAT). According to another exemplary embodiment, core device 122 may not be used and UE capabilities information as described herein is forwarded between various access devices 107 within the network, as necessary to support the UE capabilities information exchange methodology.

Referring to FIG. 2A, assume that UE 130 includes UE capabilities information exchange logic 204 that may select one or more RACS IDs for transmission to access device 107 during attachment to (or registration with) access device 107. As shown in FIG. 2A, in one implementation, UE 130 may initially transmit a connection setup message 205 to access device 107. For example, UE 130 may transmit an RRC Connection Request message 205 that includes at least identification information relating to UE 130.

In response, assuming that access device 107 is not at capacity or otherwise unavailable, access device 107 may transmit an RRC Setup message 210 to UE 130 that includes various radio parameters and configuration information needed to communicate with the network.

UE capabilities information exchange logic 204 in UE 130 may, in response to receipt of RRC Setup message 210, identify one or more RACS IDs to transmit to access device 107. Consistent with implementations described herein, although a complete set of UE capabilities information may be collectively assigned a single RACS ID, it may be advantageous and efficient to provide a plurality of different RACS IDs to a particular UE 130. In particular, different combinations of capabilities may be relevant to servicing a UE 130 in various circumstances, such as the current network capabilities, the local network configuration, network congestion, etc. As described herein, RACS IDs may be assigned to UEs 130 in a number of manners, such as by core network 120 or access device 107 during initial registration, by the device maker during manufacture, etc.

FIG. 2B illustrates an exemplary UE capabilities mapping table 230. As illustrated, UE capabilities mapping table 230 includes a listing of RACS IDs correlated to various items of UE capabilities information. For example, table 230 may include a RACS ID field 232, a supported frequency bands field 234, a maximum transmission power field 236, a maximum data rate field 238, a modulations supported field 240, a dual connectivity supported field 242, a primary cell identification field 244, a secondary cell identification field 246, a carrier aggregation support field 248, a maximum number of carriers field 250, a supported carrier aggregation type field 252, a carrier aggregation band combinations field 254, a beamforming support field 256, a maximum MIMO layers field 258, a spatial streams field 260, and a massive MIMO support field 262. As further illustrated, the table includes entries 270-1 and 270-2 (also referred to as entries 270 and generally or individually as entry 270) that each includes a grouping of fields 234 through 262 that are associated with a particular RACS ID included within RACS ID field 232.

The RACS ID and associated UE correlation information is illustrated in tabular form merely for the sake of description. In this regard, the UE capabilities mapping table 230 may be implemented in a data structure different from a table (e.g., a list, a flat file, etc.). Furthermore, the number of entries and the number and type of fields are exemplary. For example, the number of entries may depend on UE devices and the number of different combinations of values provided in the various fields 234-262. Also, fewer or additional fields of data may be associated with each RACS ID provided in field 232.

RACS ID field 232 may include data that uniquely identifies a particular combination of UE capabilities. In some implementations, the values of RACS IDs in fields 232 may be assigned or provided by core network 120 during initial device registration. In other implementations, as described below, one or more of RACS IDs may be pre-configured and assigned during manufacture of particular UEs 130.

Supported frequency bands field 234 includes information that identifies the frequency bands supported by a UE, for each supported RAT. Maximum transmission power field 236 includes information that identifies the maximum transmission power supported by a UE, for each supported RAT. Maximum data rate field 238 includes information that identifies the maximum data rate supported by a UE, for each supported RAT. Modulations supported field 240 includes information that identifies the various modulation types by a UE, for each supported RAT.

Dual connectivity supported field 242 includes information that indicates whether a UE supports dual connectivity. Primary cell identification field 244 includes information that identifies the frequency band associated with the UEs primary cell designation. Secondary cell identification field 246 includes information that identifies the frequency band associated with the UEs second cell designation.

Carrier aggregation support field 248 includes information that indicates whether a UE supports carrier aggregation. Maximum number of carriers field 250 includes information that identifies a maximum number of component carriers supported for aggregation by a UE that supports carrier aggregation. Supported carrier aggregation type field 252 includes information that indicates the types of supported carrier aggregation (e.g., contiguous or non-contiguous). Carrier aggregation band combinations field 254 includes information that identifies the supported frequency band carrier combinations supported by a UE.

Beamforming support field 256 includes information that indicates whether a UE supports beamforming. Maximum MIMO layers field 258 includes information that identifies a maximum number of MIMO layers supported by a UE. Spatial streams field 260 includes information that identifies a maximum number of spatial streams supported by a UE. Massive MIMO support field 262 includes information that indicates whether a UE supports massive MIMO.

Consistent with implementations described herein, different RACS IDs may be assigned to a UE each RACS ID including a subset of an entirety of the UEs complete capability information. For example, different RACS IDs may be associated with different combinations of supported frequency bands, different carrier aggregation combinations, etc. which may be based on known network configuration, regional limitations, etc. For example, a network operator may hold licenses to different frequency bands in different geographic regions. Accordingly, it may be advantageous to assign RACS IDs associated with the particular combinations of frequency bands.

Referring back to FIG. 2A, in response to RRC Setup message 210 from access device 107, UE capabilities information exchange logic 204 in UE 130 may identify (212) the one or more RACS IDs that correspond to the RRC Setup message. Assuming that a UE capabilities information exchange logic 204 identifies one or more RACS IDs, UE 130 may transmit an RRC Setup Complete+Network Attach/Registration Request message 214 that includes the identified RACS IDs. As briefly discussed above, UE 130 may identify all RACS IDS corresponding the UE 130 and may transmit all RACS IDS in the RCC Setup Complete message 214. In other implementations, UE 130 may transmit fewer than all RACS IDs based on known information, such as location, pre-configurations, etc.

Although the example of FIG. 2A is provided in terms of initial network attach or registration, in some implementations, UE capabilities information exchange logic 204 may be configured to identify (212) and transmit the identified RACS IDs to access device 107 as a part of another procedure (e.g., a tracking area update (TAU) procedure, a mobility update procedure (e.g., associated with a registration area (RA)), a handover procedure, etc.).

In response to the received RRC Setup Complete+Network Attach/Registration Request message 214, UE capabilities information exchange logic 206 at access device 107 may validate the received RACS ID(s) (215). For example, according to an exemplary scenario, access device 107 may determine whether the received RACS IDs correspond to known entries in UE capabilities mapping table 230. In some implementations, core network 120 may include additional a device or network function for storing and/or maintaining RACS ID mapping table 230, such as, for example, a UE Capability Management Function (UCMF). Validation of RACS ID(s) received from UE 130 may include querying or retrieving entries in mapping table 230 from UCMF, as indicated by the dashed lookup and response messages in FIG. 2A. Consistent with implementations described herein, if one or more of the received RACS IDs cannot be validated, access device 107 may request UE capabilities information via a traditional UE capability enquiry (UCE) request message (not shown).

If at least one RACS ID is validated, access device 107 retrieves (216) the content from UE capabilities mapping table 230 corresponding to the validated RACS IDs. If more than one RACS IDs is validated, access device 107 may concatenate the capabilities information from each of the validated RACS IDs to create the complete set of UE capabilities information for the UE (218). In response, access device 107 may transmit an Initial UE Message 220 to core device 122 (e.g., the AMF) that includes at least some of the retrieved and possibly concatenated set of capabilities information. For example, access device 107 may evaluate the retrieved UE capabilities information and may include those elements of information relevant to the attach request. In response, core device 122 may perform its necessary processing based on the received Initial UE Message 220 and may transmit an Initial Context Setup Request message 222 to access device 107.

By providing multiple possible RACS IDs to UE 130 based on different network capabilities and requirements, UE capabilities information exchange logic 204 at UE 130 and UE capabilities information exchange logic 206 at access device 107 are able to efficiently exchange accurate capabilities information with significantly reduced overhead and processing costs.

FIG. 2C is a diagram illustrating an exemplary process 201 of an exemplary embodiment of the UE capabilities information exchange methodology implemented in an exemplary environment. Where appropriate, similar number is applied as in FIG. 2A.

Referring to FIG. 2C, in response to RRC Setup message 210 from access device 107, UE capabilities information exchange logic 204 in UE 130 again identifies (212) the one or more RACS IDs that correspond to the RRC Setup message. Assuming that a UE capabilities information exchange logic 204 identifies one or more RACS IDs, UE 130 transmits an RRC Setup Complete message 214 that includes the identified RACS IDs.

In response to the received RRC Setup Complete message 214, UE capabilities information exchange logic 206 at access device 107 may validate the received RACS ID(s) (216). For example, according to an exemplary scenario, access device 107 may determine whether the received RACS IDs correspond to known entries in UE capabilities mapping table 230 (e.g., by querying mapping table 230 at UCMF or AMF in core network 120).

Consistent with implementations described herein, if one or more of the received RACS IDs cannot be validated, access device 107 may transmit an Initial UE Message 220 to core device 122 (e.g., the AMF) that includes the received RACS ID(s). Where some, but not all, received RACS ID(s) have been validated, an Initial UE Message 220 may include a combination of retrieved UE capabilities information and the unvalidated RACS ID(s). In response, core device 122 may validate the received RACS ID(s) and retrieve any associated capabilities information. Based on the retrieved information, core device 122 may perform its necessary processing based on the received Initial UE Message 220 and transmit the Initial Context Setup Request message 222 to access device 107. Consistent with implementations described herein, if one or more of the received RACS IDs cannot be validated at core device 120, core device 122 may request that access device 107 request UE capabilities information from UE 130 via a traditional UE capability enquiry (UCE) request message (not shown).

FIG. 2D is a diagram illustrating an exemplary process 280 of an exemplary embodiment of the UE capabilities information exchange methodology implemented in an exemplary environment. Where appropriate, similar number is applied as in FIGS. 2A and 2C.

Referring to FIG. 2D, in response to RRC Setup message 210 from access device 107 that indicates a particular region or combination of available network resources, UE capabilities information exchange logic 204 in UE 130 determines that an update or change in capabilities information has occurred since a last network attach (281). For example, as briefly described above, such an update or change may include a modem software update impacting one or more frequencies or network features identified in the RRC Setup message (210).

In response, UE capabilities information exchange logic 204 transmits an RRC Setup Complete message 282 that includes an indication that an update or change has occurred. For example, RRC Setup Complete message 282 may include a pre-configured RACS ID value indicative of a software change or other update. Alternatively, RRC Setup Complete message 282 may include a null value of the RACS ID. In any event, upon receipt of RRC Setup Complete message 282, access device 107 validates the update indication (283) and transmits a UCE request message 284 to UE 130. In response, UE 130 generates and transmits one (or more) UE Capabilities Information (UCI) messages 286 to access device 107 that includes the complete set up UE capabilities information, as updated. In response, access device 107 creates or overwrites (288) the RACS IDs for UE 130 based on the updated capabilities information.

Access device 107 then transmits the Initial UE Message 220 to core device 122 (e.g., the AMF) that includes the updated set of capabilities information. In addition, in some implementations, access device 107 further transmits (290) the updated RACS ID to core device 122, where it is stored and/or transmitted to other access devices 107 in access network 105 for use during subsequent attachment/registration requests by UE 130.

FIGS. 2A and 2C-2D illustrates exemplary steps or operations of processes 200, 201, and 280, respectively. However, according to other exemplary embodiments, these processes may include additional, different, and/or fewer steps or operations than those illustrated and described in relation to FIGS. 2A, 2C, and 2D.

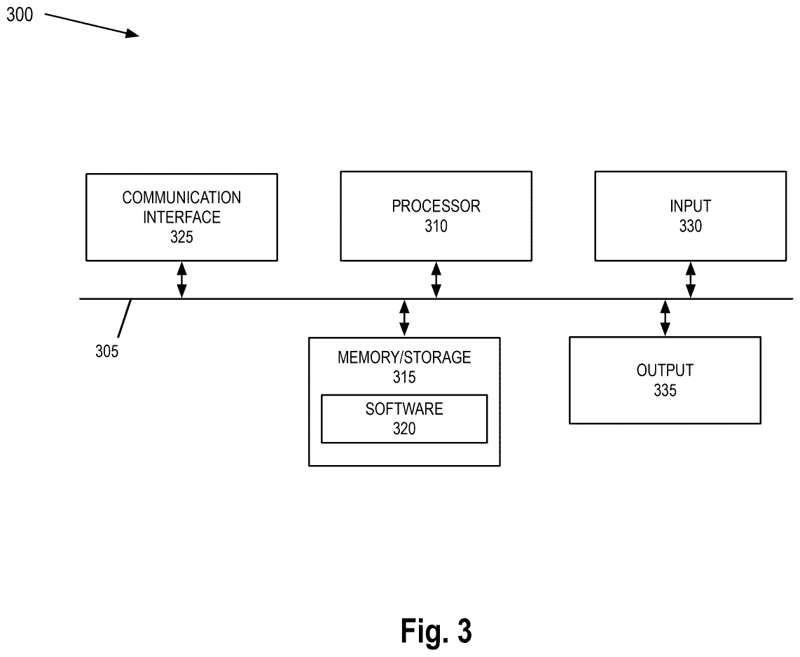

FIG. 3 is a diagram illustrating exemplary components of a device 300 that may be included in one or more of the devices described herein. For example, device 300 may correspond to access device 107, external device 117, core device 122, UE 130, and/or other types of network devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), processing logic, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium. Memory/storage 315 may store data, software, and/or instructions related to the operation of device 300.

Software 320 includes an application or a program that provides a function and/or a process. As an example, with reference to end device 130, software 320 may include an application that, when executed by processor 310, provides a function and/or a process of the radio spectrum binding service, as described herein. According to another example, with reference to access device 107 and core device 122, software 320 may include an application that, when executed by processor 310, provides a function and/or a process of the radio spectrum binding service, as described herein. Software 320 may also include firmware, middleware, microcode, hardware description language (HDL), and/or another form of instruction. Software 320 may also be virtualized. Software 320 may further include an operating system (OS) (e.g., Windows, Linux, Android, proprietary, etc.).

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life cycle (e.g., refreshed, paused, suspended, rebooted, or another type of state or status), using well-known virtualization technologies. For example, access device 107, core device 122, external device 117, and/or another type of network device or UE/end device 130, as described herein, may be a virtualized device.

Device 300 may be configured to perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 may configure device 300 and/or cause processor 310 to perform a function or a process described herein. Alternatively, for example, according to other implementations, device 300 may be configured to perform a function or a process described herein based on the execution of hardware (processor 310, etc.).

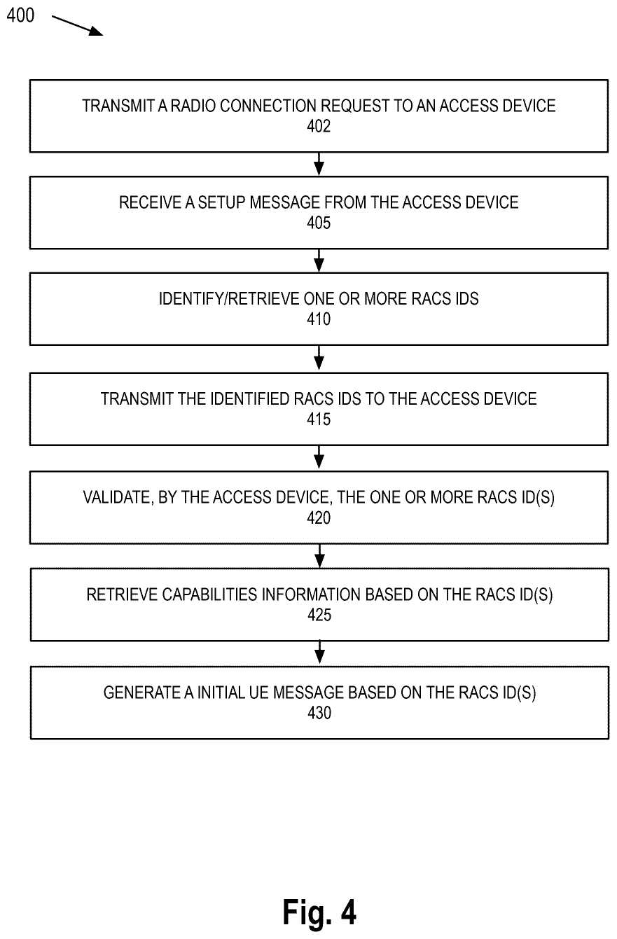

FIG. 4 is a flow diagram illustrating an exemplary process 400 of an exemplary embodiment of the UE capabilities information exchange methodology. According to an exemplary embodiment, process 400 may be implemented by a combination of UE 130, access device 107 and/or core device 122. According to an exemplary implementation, a processor may execute software to perform a step (in whole or in part) of process 400, as described herein. Alternatively, a step (in whole or in part) may be performed by execution of only hardware. According to an exemplary embodiment of process 400, UE 130 may be registered with core network 120 and one or more RACS IDs may be associated with UE 130 in UE capabilities mapping table 230.

In block 402, UE 130 may transmit a radio connection request to access device 107. For example, UE 130 may transmit RRC Connection Request message 205 to access device 107. In response, UE 130 may receive a RRC Setup message from access device 107 (block 405). UE 130 identifies or retrieves one or more RACS IDs (block 410). For example, UE capabilities information exchange logic 204 on UE 130 compares the network capabilities and resources information included in the setup message with the capabilities associated with its assigned RACS IDs.

UE 130 generates and transmits a RRC Setup Complete+Network Attach/Registration Request message to access device 107 that includes the identified RACS IDs (block 415). For example, UE capabilities information exchange logic 204 includes the list of applicable RACS IDs into the setup complete and network attach request message. It should be understood that the specific nature of each message and its content is dependent on the RAT being utilized. For example, in an LTE or 5G NSA implementation using an eNB as access device 107, the message may include a non-access stratum (NAS) Attach Request message in the payload of the RRC Setup Complete message. Conversely, for a 5G SA implementation using gNB as access device 107, the message may include a NAS Registration Request message in the payload of a RRC Setup Complete message.

In response, access device 107 validates the received RACS IDs (block 420). For example, UE capabilities information exchange logic 206 in access device 107 extracts the RACS IDs from the setup complete message and looks RACS IDs up in UE capabilities mapping table 230. In some implementations, validates the received RACS IDs by querying core device 122, such as MME, AMF, UCMF, etc. Access device 107 retrieves the relevant capabilities information for UE 130 based on the validated RACS IDs (block 425). For example, UE capabilities information exchange logic 206 in access device 107 extracts UE capabilities information from the corresponding RACS ID entries 270 in mapping table 230 or receives such extracted UE capabilities information from core device 122.

Access device 107 then generates and transmits an initial UE message to core device 122 in core network 120 based on the extracted UE capabilities information (block 430). For example, UE capabilities information exchange logic 206 in access device 107 concatenates the information from each retrieved RACS ID entry 270 into an initial UE message and transmits the message to, for example, the AMF in core network 120.

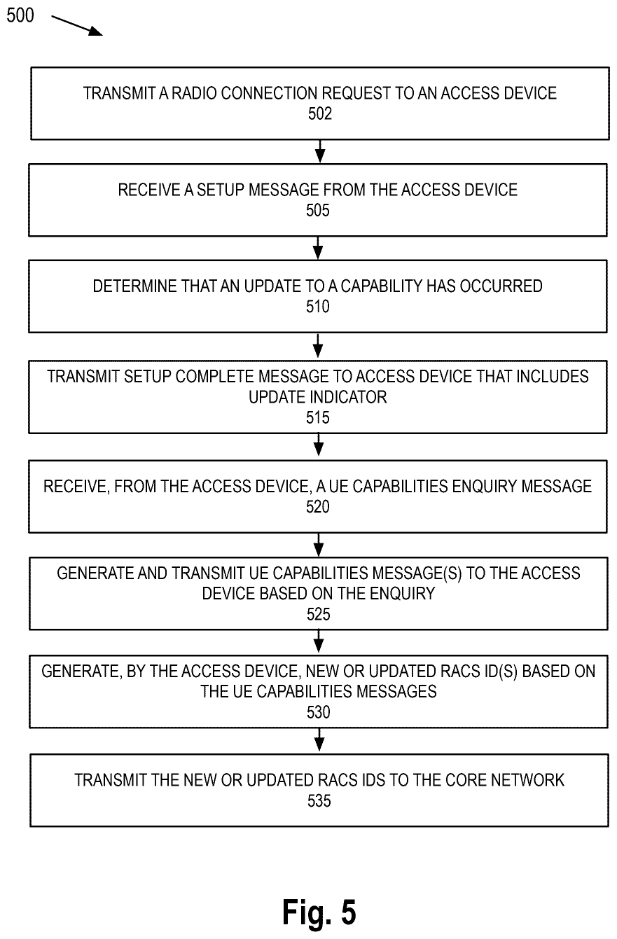

FIG. 5 is a flow diagram illustrating another exemplary process 500 of an exemplary embodiment of the UE capabilities information exchange methodology. According to an exemplary embodiment, process 500 may be implemented by a combination of UE 130, access device 107 and/or core device 122. According to an exemplary implementation, a processor may execute software to perform a step (in whole or in part) of process 500, as described herein. Alternatively, a step (in whole or in part) may be performed by execution of only hardware. According to an exemplary embodiment of process 500, UE 130 may be registered with core network 120 and one or more RACS IDs may be associated with UE 130 in UE capabilities mapping table 230.

In block 502, UE 130 may transmit a radio connection request message to access device 107. For example, UE 130 may transmit RRC Connection Request message 205 to access device 107. In response to the request, access device 107 may transmit a RRC Setup message to UE 130 (block 505). Consistent with the embodiment of FIG. 5, UE 130 determines that an update or change to a capability has occurred (block 510). For example, as described above, UE capabilities information exchange logic 204 may identify one or more updates that cause changes in modem features or changes in the carrier aggregation or dual connectivity features of UE 130.

In response, UE 130 transmits a RRC Setup Complete+Network Attach Request message to access device 107 that indicates that an update has occurred that prevents accurate capabilities exchange via known RACS ID(s) (block 515). For example, UE 130 generates a RRC setup complete+network attach request message that includes either a null entry for RACS ID or a pre-defined RACS ID that indicates that a capabilities-related update has occurred. In response, access device 107 transmits a UCE message to request updated capabilities information from UE 130 (block 520).

Based on the received UCE message, UE 130 generates and transmits one or more UE capabilities information messages to access device 107 (block 525). In response, access device 107 generates new RACS ID entries based on the updated capabilities information associated with UE 130 (block 530). In some implementations, the updated UE capabilities information received in block 525 includes an indication of the relevant prior RACS IDS. In such an implementation, access device 107 may update its table 230 based on the updated capabilities information. Such an update implementations (in contrast to creation of replacement/new RACS IDs) is useful when the RACS IDs are uniquely assigned to UE 130 and cannot be easily changed.

In any event, the updated/new RACS IDS and associated capabilities information may then be transmitted to core device 122 for dissemination throughout the network, for use in subsequent attachment requests (block 535).

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 4 and 5 and series of acts in FIGS. 2A, 2C and 2D, the order of the blocks and/or acts may be modified according to other embodiments. Further, non-dependent blocks or acts may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a user equipment device (UE), a setup message from an access network device;
identifying, by the UE, one or more radio capability signaling optimization identifiers (RACS IDs), wherein each of the one or more RACS IDs identifies a set of radio capabilities;
generating, by the UE, a response to the access network device that includes the one or more RACS IDs; and
retrieving, by the access network device, UE capabilities information based on the one or more RACS IDs; and
transmitting, by the access network device, a message to a core network device that includes at least some of the UE capabilities information.

2. The method of claim 1, wherein the one or more identified RACS IDs comprise two or more RACS IDs, and
wherein transmitting, by the access network device, a message to a core network device that includes at least some of the UE capabilities information further comprises:
concatenating the retrieved UE capabilities information for each of the two or more RACS IDs, and
wherein the message to the core network device includes at least the concatenated UE capabilities information.

3. The method of claim 1, wherein the one or more identified RACS IDs comprise all of the RACS IDs that are associated with the UE, and
wherein transmitting, by the access network device, a message to a core network device that includes at least some of the UE capabilities information further comprises:
identifying the retrieved UE capabilities that correspond to attachment by the UE to the access network device, and
wherein the message to the core network device includes at least the identified UE capabilities information.

4. The method of claim 1, further comprising:
validating, by the access network device, the one or more RACS IDs included in the response from the UE.

5. The method of claim 4,
wherein retrieving the UE capabilities information based on the one or more RACS IDs further comprises:
retrieving the UE capabilities information from a core network device that stores a mapping table of RACS IDs to UE capabilities information.

6. The method of claim 5, further comprising:
transmitting a UE capabilities enquiry message to the UE when at least one of the one or more RACS IDs is not validated.

7. The method of claim 1, further comprising:
determining that at least one UE capabilities update has occurred;
generating, by the UE, a response to the access network device that indicates that at least one UE capabilities update has occurred;
receiving, from the access network device, a UE capabilities enquiry message based on the indication that the at least one UE capabilities update has occurred; and
transmitting a UE capabilities information message to the access network device that includes updated capabilities information.

8. The method of claim 7, further comprising:
generating and storing, by the access network device, at least one new or updated RACS ID based on the updated capabilities information.

9. The method of claim 8, further comprising:
forwarding the at least one new or updated RACS ID to the core network device.

10. The method of claim 7, wherein the determining that at least one UE capabilities update has occurred comprises determining that a modem update has occurred.

11. The method of claim 7, wherein generating, by the UE, a response to the access network device that indicates that at least one UE capabilities update has occurred further comprises:
generating the response to include a preconfigured RACS ID that indicates the update.

12. A system comprising:
a user equipment device (UE), wherein the UE is configured to:
receive a setup message from an access network device;
identify one or more radio capability signaling optimization identifiers (RACS IDs), wherein each of the one or more RACS IDs identifies a set of radio capabilities; and
generate a response to the access network device that includes the one or more RACS IDs; and
the access network device, wherein the access network device is configured to:
retrieve UE capabilities information based on the one or more RACS IDs; and
transmit a message to a core network device that includes at least some of the UE capabilities information.

13. The system of claim 12, wherein the one or more identified RACS IDs comprise two or more RACS IDs, and
wherein the access network device configured to transmit a message to a core network device that includes at least some of the UE capabilities information is further configured to:
concatenate the retrieved UE capabilities information for each of the two or more RACS IDs,
wherein the message to the core network device includes at least the concatenated UE capabilities information.

14. The system of claim 12, wherein the one or more identified RACS IDs comprise all of the RACS IDs that are associated with the UE, and
wherein the access network device configured to transmit a message to a core network device that includes at least some of the UE capabilities information is further configured to:
identify the retrieved UE capabilities that correspond to attachment by the UE to the access network device,
wherein the message to the core network device includes the identified UE capabilities information.

15. The system of claim 12, wherein the access network device is further configured to:
validate the one or more RACS IDs included in the response from the UE.

16. The system of claim 15, wherein the access network device configured to retrieve the UE capabilities information based on the one or more RACS IDs is further configured to:
Retrieve the UE capabilities information from a core network device that stores a mapping table of RACS IDs to UE capabilities information.

17. The system of claim 16, wherein the access network device is further configured to:
transmit a UE capabilities enquiry message to the UE when at least one of the one or more RACS IDs is not validated.

18. The system of claim 12, wherein the UE is further configured to:
determine that at least one UE capabilities update has occurred;
generate a response to the access network device that indicates that at least one UE capabilities update has occurred;
receive, from the access network device, a UE capabilities enquiry message based on the indication that the at least one UE capabilities update has occurred;
transmit a UE capabilities information message to the access network device that includes updated capabilities information.

19. The system of claim 18, wherein the access network device is further configured to:
generate and store at least one new or updated RACS ID based on the updated capabilities information.

20. A non-transitory computer-readable storage medium storing instructions executable by a processor of one or more network devices, wherein the instructions include instructions to:
receive a setup message from an access network device;
identify one or more radio capability signaling optimization identifiers (RACS IDs), wherein each of the one or more RACS IDs identifies a set of radio capabilities;
generate a response to the access network device that includes the one or more RACS IDs; and
retrieve UE capabilities information based on the one or more RACS IDs; and
transmit a message to a core network device that includes at least some of the UE capabilities information.
